(19) United States
(12) Patent Application Publication
(10) Pub. No.: US 2005/0071213 A1
(43) Pub. Date: Mar. 31, 2005

(54) Method and apparatus to reschedule room resources

(75) Inventors: David Bruce Kumhyr, Austin, TX (US); Jan K. Melear, Austin, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 10/674,965

(22) Filed: Sep. 30, 2003

(51) Int. Cl. G06F 17/60

(52) U.S. Cl. 705/8

(57) ABSTRACT

A method, apparatus, and computer instructions for allocating meeting room resources. A database of meeting room resources is provided. The database includes attributes describing physical characteristics of each meeting room in the meeting room resources. A request for a meeting room is received. The request includes at set of attributes. A determination is made as to whether the meeting room meeting the set of attributes is available. In response to a determination that the meeting room is available, the meeting room is allocated to a user.

### BACKGROUND OF THE INVENTION

1. Technical Field

The present invention relates generally to an improved data processing system and in particular to a method and apparatus for allocating resources. Still more particularly, the present invention relates to a method, apparatus, and computer instructions for reallocating room resources.

2. Description of Related Art

Resources, such as conference rooms or other types of rooms in a business or organizational setting, may be shared by numerous users. These types of resources are typically limited resources in which demand may often exceed the number of rooms that are available. With limited room resources, reservation systems are employed to allow users to reserve these types of resources. Different software programs and applications are available for providing easy reservation of these types of resources.

When a need arises to reallocate or reschedule a room resource, the presently used process is a manual and labor-intensive process. For example, in Company ABC, resources, in the form of conference rooms, are reserved at the beginning of the year. Different conference rooms may be reserved by users for particular days throughout the year, even though those resources may not be needed each time a reservation is made. As a result, available conference rooms become scarce and limited. For example, a particular conference room may be reserved by a team for every Monday for the entire year. If the team decides that a conference room of a different size is needed or that a conference room is needed for a different day, the rescheduling of rooms requires one or more members of the team to identify other conference rooms. If no available conference rooms are present, the team members may be required to negotiate with other users to obtain a desired conference room on a different day. As a result, rescheduling or reallocating room resources is frustrating because of the tedious and long process that is required to find another conference room. This process may involve the different team members physically traveling to the different conference rooms and looking for one of a suitable size and having suitable amenities, such as a conference phone or whiteboard. After finding a room, the team members must then identify who has reservations for the room on the particular day or days desired. Thereafter, a negotiation must be made with the person or persons who have reserved the desired room. This process is long and tedious.

Therefore, it would be advantageous to have an improved method, apparatus, and computer instructions for allocating and reallocating room resources.

### SUMMARY OF THE INVENTION

The present invention provides a method, apparatus, and computer instructions for allocating meeting room resources. A database of meeting room resources is provided. The database includes attributes describing physical characteristics of each meeting room in the meeting room resources. A request for a meeting room is received. The request includes at set of attributes. A determination is made as to whether the meeting room meeting the set of attributes is available. In response to a determination that the meeting room is available, the meeting room is allocated to a user.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in accordance with a preferred embodiment of the present invention;

FIG. 2 is a block diagram of a data processing system that may be implemented as a server in accordance with a preferred embodiment of the present invention;

FIG. 3 is a block diagram of a data processing system in accordance with a preferred embodiment of the present invention;

FIG. 4 is a diagram illustrating components used in allocating and reallocating room resources in accordance with a preferred embodiment of the present invention;

FIG. 5 is a diagram illustrating an entry in a room resource database in accordance with a preferred embodiment of the present invention;

FIG. 6 is a diagram illustrating a presentation of room resources in accordance with a preferred embodiment of the present invention;

FIG. 7 is a display of suitable alternative conference room resources in accordance with a preferred embodiment of the present invention;

FIG. 8 is a flowchart of a process for allocating room resources in accordance with a preferred embodiment of the present invention;

FIG. 9 is a flowchart of a process for reallocating room resources in accordance with a preferred embodiment of the present invention; and

FIG. 10 is a flowchart of a process for rescheduling a room resource in accordance with a preferred embodiment of the present invention.

### DETAILED DESCRIPTION OF THE PREFERRED EMBODIMENT

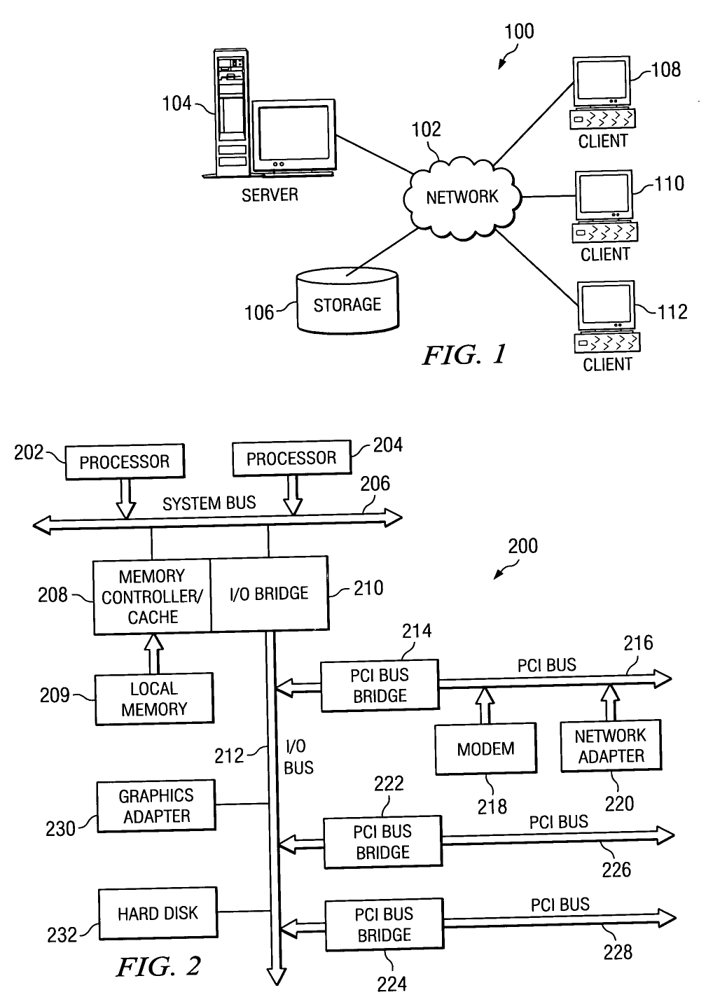

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in boards.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pSeries system, a product of International Business Machines Corporation in Armonk, N.Y., running the Advanced Interactive Executive (AIX) operating system or LINUX operating system.

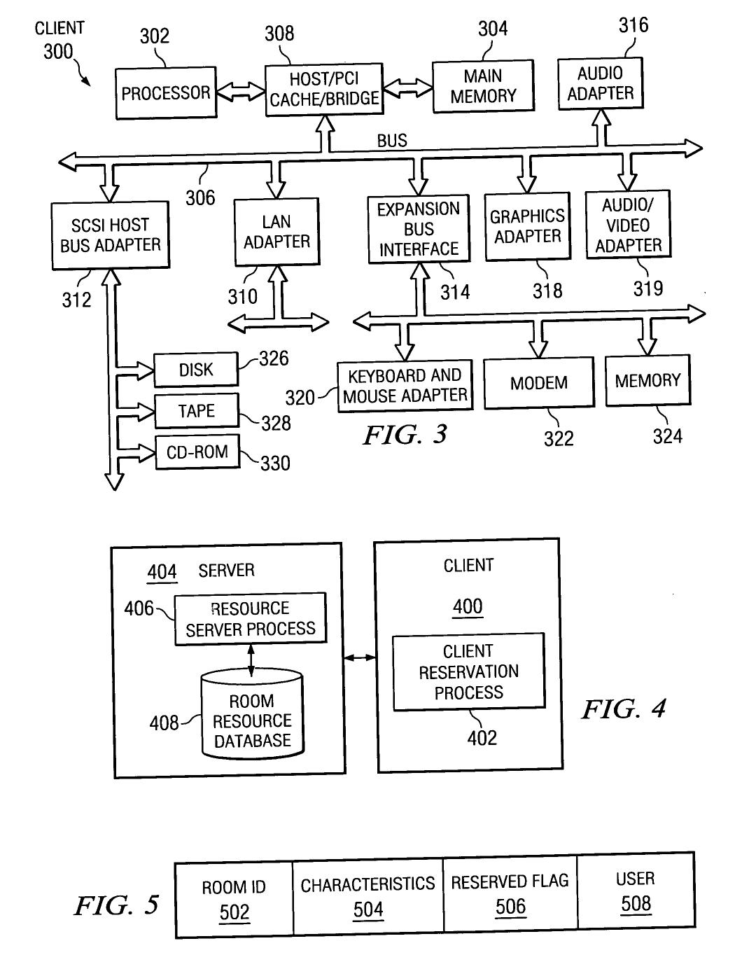

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented programming system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash read-only memory (ROM), equivalent nonvolatile memory, or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interfaces. As a further example, data processing system 300 may be a personal digital assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

The present invention provides an improved method, apparatus, and computer instructions for allocating room resources. These room resources in these illustrative examples are meeting room resources, such as, for example, conference rooms. Other types of meeting room resources include, for example, an auditorium or classroom. These room resources may have various locations. For example, room resources may be located on different floors, within the same building, or in different buildings on a campus. Further, these resources also may be located in different cities, states, or countries.

The mechanism of the present invention identifies current users who have reservations for a required or selected room resource. Suitable available alternatives may be identified using the mechanism of the present invention. This list of alternative room resources may be employed by a user to negotiate with another user to reallocated or change reservations for a desired room resource. In particular, a user who is unable to find an open or unreserved room resource meeting desired criteria or attributes may identify a desired room that is already reserved. These attributes describe physical characteristics of a room resource. The identification is made by comparing the desired attributes with attributes for room resources stored in a database. Based on this identification, the list of suitable alternatives is identified for the user who has the reservation for the desired room. These alternatives may be identified through criteria or other attributes entered by users making reservations. With this list, the user may then approach the second user with the desired room and attempt to negotiate a reallocation of resources by presenting suitable alternatives to that second user.

Further, a preemptive modification request with a list of alternatives available that the original requestor can substitute is provided. In this case, the first user, who is unable to locate a room for reservation, may identify a desired room that is already reserved by a second user. The user may select this room and if the user's priority is higher than that of the second user, the second user's reservation is bumped or canceled in place of the first user. The first user may substitute a second room from the list for the selected room or may have that list sent to the second user.

This mechanism also allows for keeping track of substitutions and notifies the requester of progress towards an objective. The progress of messages may be tracked based on the current state of the request. For example, a notification may be generated to indicate that a number of suitable meeting room resources are reserved, but notices may be sent requesting release of the resources. Next, another state that may be tracked is a state in which notifications have been sent. Another state includes notifications that have been received. Read messages also may be tracked as well as answers that accept or decline the request to release meeting room resources. Additionally, messages that notify users that rescheduling of resources is unnecessary also may be tracked. This type of notification and tracking of messages allows for human intervention to occur at strategic times to ensure the success of the preemption.

Turning now to FIG. 4, a diagram illustrating components used in allocating and reallocating room resources is depicted in accordance with a preferred embodiment of the present invention. A user at client 400 may make reservations for room resources through client reservation process 402. Client 400 may be implemented using a data processing system, such as data processing system 300 in FIG. 3. These reservation requests may be sent to server 404. Server 404 may be implemented using a data processing system, such as data processing system 200 in FIG. 2. In particular, resource server process 406, running on server 404, receives requests for reservations as well as reallocating room resources.

The information regarding room resources is stored in room resource database 408 on server 404. Room resource database 408 includes attributes about the physical characteristics of different room resources. For example, the capacity of a room, the location of the room, and amenities may be stored as attributes within room resource database 408. Amenities may include, for example, a presence of a whiteboard, an overhead projector, a conference phone, wireless network connections, wired network connections, a podium, and a public address system.

Further, room resource database 408 also includes an identification as to whether particular room resources-have been reserved as well as an identification of the reserving party or user. This information allows the user at client 400 to identify the different characteristics or features of room resources without having to physically travel to each one. Further, this data in room resource database 408 also may be used to process requests for room resources in which those requests contain parameters of desired characteristics, such as the capacity that is desired for a room.

A user client 400 may generate a room request through client reservation process 402. In these examples, this room request includes various criteria or attributes entered by the user. The attributes may include the room capacity required as well as amenities that are desired. Based on the user input, a request received by resource server process 406 may be processed to identify matching rooms from room resource database 408. A list of unreserved rooms matching the criteria entered by the user is returned to client reservation process 402 in client 400. The rooms in this list are then presented to the user. The user may select one or more of these rooms from the list for reservation.

If, however, no rooms meeting the attributes entered by the user are present, resource server process 406 may then identify reserved room resources matching the criteria. These results are then returned to client reservation process 402 as a list for display to the user. The results are then presented to the user by client reservation process 402. A user may select one of the desired rooms.

In response to such a selection, resource server process 406 then identifies suitable alternatives for the user who holds the reservation for the selected room. These suitable alternatives may be sent back as a list to client reservation process 402. At that time, if some of these suitable alternatives are rooms that are unreserved, then the user may contact the person who has reserved the selected room to see whether an agreement can be made to allow the user to reallocate the reservation of the selected room and have the user who holds the reservation to the selected room choose a different room. If the user holding the reservation agrees to use a different room, a selected room may be released for reservation by the user requesting this room. These types of agreements often may be possible because the person having the reserved room may find another room just as desirable as the current one while other rooms that are currently available do not meet the criteria of the user.

For example, a first user may desire to have a room that holds at least ten people containing a conference phone on Monday. In generating a request, the user may be unable to find an unreserved room meeting this attribute. The result may include a room meeting the attribute that is already reserved. The reserved conference room may be a conference room containing a conference phone, a whiteboard, and an overhead projector that holds fifteen people. The second user having the reservation for that room may only require a conference room that holds five people with a conference phone. In this case, conference rooms that hold five people and contain a conference phone may be acceptable substitutes to the second user while the first user cannot use those types of conference rooms because they do not have sufficient capacity. Thus, if the first user is able to offer a room with sufficient capacity and the appropriate amenities, then the second user having the reservation to the desired conference room may likely agree to change rooms.

With reference now to FIG. 5, a diagram illustrating an entry in a room resource database is depicted in accordance with a preferred embodiment of the present invention. In this illustrative example, entry 500 is an example of an entry located in a database, such as room resource database 408 in FIG. 4. As depicted, entry 500 includes Room ID 502, characteristics 504, reserved flag 506, and user 508. Room ID 502 is, in this example, an alphanumeric designation of a room. This designation may be the name of a room or may be merely a numerical identifier.

Characteristics 504 contain attributes about the various physical characteristics of the room. For example, the location of the room, the capacity of the room, and various amenities present in the room may be located within characteristics 504. Reserved flag 506 is set if the room has been reserved. Further, user 508 contains an identification of the user as well as a priority for the user if a priority system is being used for allocating resources.

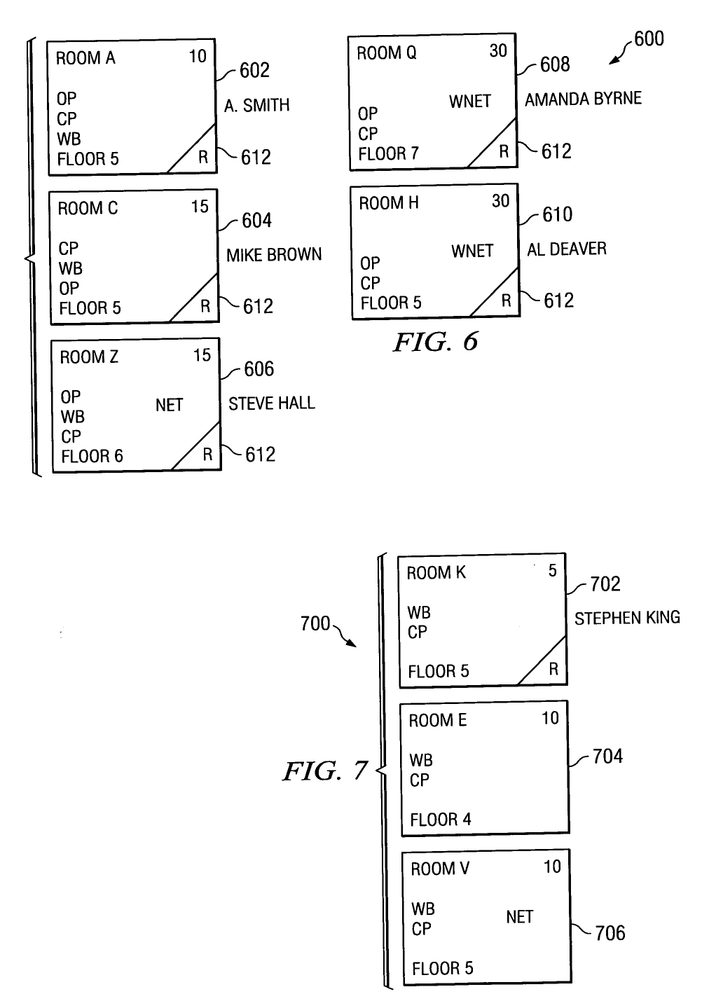

Turning now to FIG. 6, a diagram illustrating a presentation of room resources is depicted in accordance with a preferred embodiment of the present invention. Display 600 in this example is an example of a display presented to a user by client reservation process 402 in client 400. Display 500 is presented, in these illustrative examples, in the event that no available rooms meeting the user's desired attributes are available. Suitable conference rooms already reserved are illustrated in display 600. In this illustrative example, the user desires a conference room having a capacity of at least ten people, which contains an overhead projector and a conference phone. Entries 602, 604, 606, 608, and 610 are entries representing conference rooms meeting the criteria of the user. Entry 602 is a named Room A having a capacity of ten with an overhead projector (OP), a conference phone (CP), and a whiteboard (WB). Indicator 612 in entry 602 indicates that the room is reserved. Further, entry 602 indicates that this conference room is reserved by A. Smith.

This information regarding the room name and characteristics of the room is available to the user because this type of information is stored in a database, such as room resource database 408 in FIG. 4. Additional information shown in display 600 is the floor on which each of these rooms is located. The date on which different reservations may be found for the room may be presented if indicator 612 in entry 602 is selected. Information as to all dates on which this room is reserved may be identified through selecting indicator 612.

Entry 604 illustrates Room C on floor 5. This conference room has a conference phone, a whiteboard, and an overhead projector. This conference room has a capacity of fifteen and is reserved by Mike Brown. Entry 606 is for Room Z having a capacity of fifteen people on floor 6. The amenities in Room Z include an overhead projector, a whiteboard, a conference phone, and wired network connections (NET). This conference room is reserved by Steve Hall.

In entry 608, Room Q is located on floor 7 and has a capacity of 30 people containing an overhead projector, a conference phone, and wireless network capability (WNET). Entry 608 indicates that Room Q is reserved by Amanda Byrne. In entry 610, Room H on floor 5 is reserved by Al Deaver and has a capacity of 30. The amenities include an overhead projector, a conference phone, and wired network capability.

In this example, all of the conference rooms meeting the criteria of the user have been reserved. As a result, the user is unable to merely select a conference room for reservation. The user may select one of the entries, such as entry 604. By selecting this entry, a result of acceptable substitutes based on criteria or desired attributes entered by Mike Brown is returned.

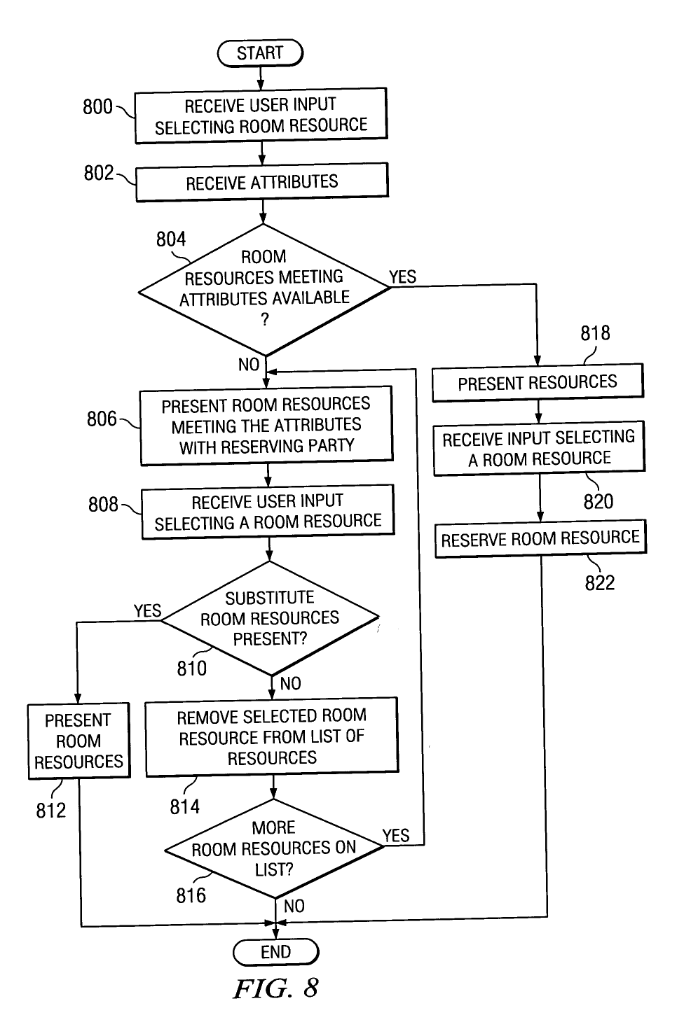

Turning next to FIG. 7, a display of suitable alternative conference room resources is depicted in accordance with a preferred embodiment of the present invention. In this example, display 700 includes entries 702, 704, and 706. These entries are ones meeting the criteria entered by Mike Brown as illustrated in FIG. 6. The criteria in this example is a room having a capacity of five persons and including a conference phone as the desired amenity. Entry 702 is Room K on floor 5 having a capacity of 5 is reserved by Steven King. The amenities in this conference room include a whiteboard and a conference phone. Entry 704 is Room E on floor 4 having a capacity of ten containing a whiteboard and a conference phone. This particular room resource is unreserved in this example.

Entry 706 is another unreserved room resource for Room V on floor 5 having a capacity of ten. This room contains a whiteboard, a conference phone, and wired network connections. Using display 700, the user may automatically reserve the rooms represented in entry 704 and 706. At this point, the user may contact Mike Brown and determine whether an agreement to reallocate room resources may be made between the parties.

Depending on the particular implementation, a priority scheme may be implemented such that a selection of one of the unreserved rooms causes an automatic reallocation of room resources without user intervention. In this case, entry 604 is allocated to the user while entry 704 or entry 706 is reallocated to Mike Brown. In yet another implementation, if the user has an appropriate priority, selection of room 604 results in an automatic reallocation of the room to the user. A notification is then sent to Mike Brown along with a presentation of the room resources displayed in display 700.

At this point, that reserving party may then select another resource and bump or reallocate resources by selecting entry 702 if sufficient priority is present. The displays shown in FIGS. 6 and 7 are presented for purposes of illustration and are not meant to limit the manner in which information may be presented using the mechanism of the present invention. In other cases, other types of graphical representations may be used to represent room resources. Further, the presentation may be in an audio format using a text to speech conversion of data.

In this manner, allocation of room resources occurs more efficiently using the mechanism of the present invention. The mechanism of the present invention stores data about the characteristics of the different room resources to allow easy facilitation of a selection of room resources as well as allowing for reallocation of these resources based on a negotiation process or a priority process depending on the particular implementation.

Turning next to FIG. 8, a flowchart of a process for allocating room resources is depicted in accordance with a preferred embodiment of the present invention. The process illustrated in FIG. 8 may be implemented in a process, such as resource server process 406 in FIG. 4. This process is included in a resource scheduling system when a constrained resource is needed.

The process begins by receiving a user input and selecting a room resource (step 800). Then, attributes are received (step 802). These attributes include various physical characteristics, such as, for example, a capacity, amenities needed in the room, location of the room, and a date or time of availability. As mentioned above, these amenities may include an overhead projector, a conference phone, wired network facilities, wireless network facilities, and various multimedia capabilities.

After the attributes are received, a determination is made as to whether any resources meeting the attributes are available (step 804). The determination may be made in these examples through querying a database, such as room resource database 408 in FIG. 4. The selection of the room and the attributes received from the user may be received through a client reservation process, such as client reservation process 402 in FIG. 4. If no room resources meeting the attributes are available, room resources are listed meeting the attributes along with a reserving party (step 806). This listing of room resources may include sending results to a client for display in these examples. The display may be, for example, display 600 in FIG. 6. The listing of room resources may be based on an order in descending hierarchy. This type of listing is based on an assumption that a person lower in the hierarchy is more likely to yield to someone higher in the hierarchy making a request to reallocate room resources.

Thereafter, a user input is received selecting a room resource (step 808). A determination is made as to whether substitute room resources are present for the selected room resource (step 810). In these examples, the determination is made by identifying the criteria entered by the reserving party and determining whether room resources are present that meet those attributes. These attributes may be stored in a database, such as room resource database 408 in FIG. 4. For example, a room resource having a projector may be the criteria made by the reserving party in step 806. As a result, another room on a different floor or in an adjacent building having this particular attribute may be identified.

If substitute room resources are present, these room resources are presented (step 812). The display of resources in step 812 may be made using a display, such as display 700 in FIG. 7. The process terminates thereafter. At this point, the user may negotiate with the reserving party identified in step 806 to see whether the presented room resources may be acceptable to allow for reallocation. Additionally, the process also may automatically reserve available room resources presented in step 812 and hold those room resources in case an agreement can be made to reallocate room resources.

With reference again to step 810, if substitute room resources are not present, the process then removes the room resource selected by the user from the list presented in the display (step 814). Thereafter, a determination is made as to whether additional room resources are present in the list displayed (step 816). If additional room resources are present, the process returns to step 806 to present the list to the user as described above. In these examples, if substitute room resources are available, a reservation may be made to hold those room resources in the name of the user having the reservation for the room resource selected in step 808. Otherwise, the process terminates. If the user is able to persuade user holding a reservation to the room resource selected in step 808 to use a substitute room resource, then, the desired room may be reallocated to the user selecting the room resource.

With reference again to step 804, if room resources meeting the criteria are available, those room resources are presented to the user (step 818). Thereafter, input selecting a resource from the list is received (step 820). The room resource is then reserved for the user (step 822) with the process terminating thereafter. In step 822, a reservation of a room resource results in a room resource database being updated to reflect the reservation. This room resource may be, for example, room database 408 in FIG. 4. The progress towards the objective of obtaining a room resource may be tracked through messages, such as ones to indicate if resources are present but reserved, notifications that messages have been sent requesting release of a room resource, notifications that messages have been received, notifications that messages have been read, answers received that decline or accept the request to release a room resource, and messages notifying users that release of room resources are no longer needed.

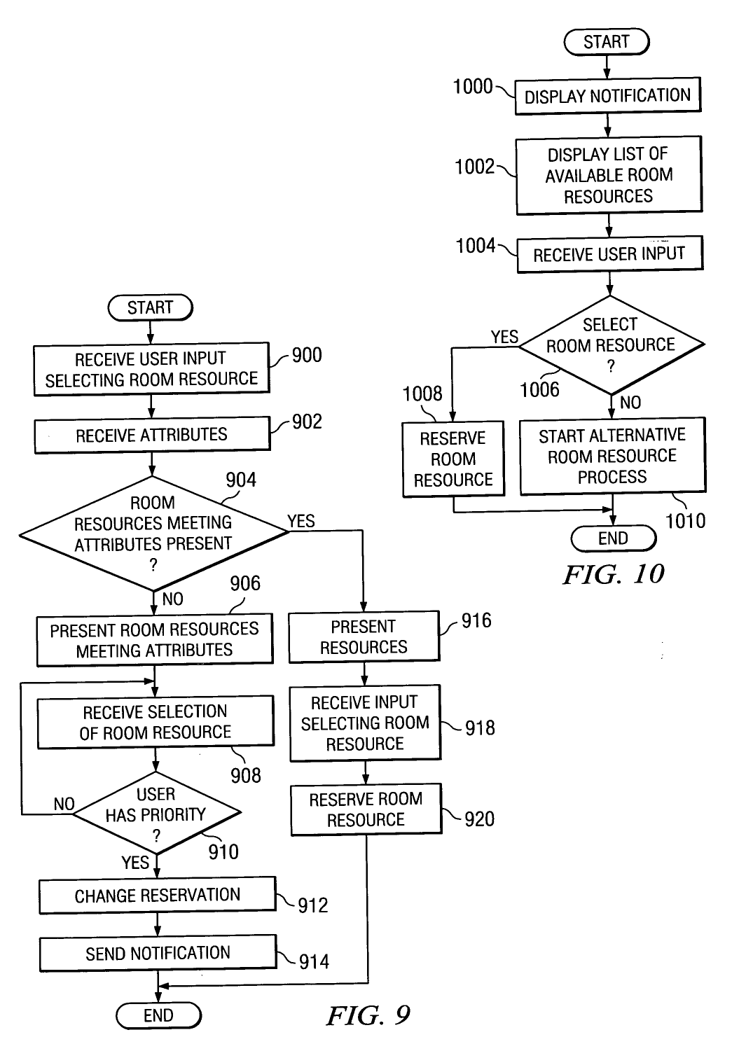

Turning now to FIG. 9, a flowchart of a process for reallocating room resources is depicted in accordance with a preferred embodiment of the present invention. The process illustrated in FIG. 9 may be implemented in a process, such as resource server process 406 in FIG. 4. In this illustrative example, the process provides for reallocation of room resources based on priorities. For example, a first user may have a higher priority with respect to a second user. As a result, the first user may bump or cause an automatic reallocation of room resources if the first user selects a room reserved by the second user.

The process begins by receiving a user input selecting a room resource (step 900). Thereafter, criteria for the room resource is received (step 902). Then, a determination is made as to whether room resources meeting the attributes are present. If room resources meeting the attributes are not present, then room resources meeting the attributes are presented (step 906). These room resources may be presented as a list in a display, such as display 600 in FIG. 6. A selection of a resource is then received (step 908).

A determination is made as to whether the user has priority over the person having the reservation of the selected room resource (step 910). If the user does not have priority, the process returns to step 908 to receive another selection. Otherwise, the reservation is changed to reflect the reservation for the user (step 912). Thereafter, a notification is sent to the person previously having the reservation for the room resource (step 914) with the process terminating thereafter. This notification indicates that the room resource has been reallocated. Further, another process may be initiated to allow the party who has been bumped from the room resource to make an alternate selection.

With reference again to step 904, if room resources meeting the criteria are present, these room resources are presented (step 916). Thereafter, input selecting the resource is received (step 918), and the room resource is then reserved (step 920) with the process terminating thereafter.

With reference now to FIG. 10, a flowchart of a process for rescheduling a room resource is depicted in accordance with a preferred embodiment of the present invention. The process illustrated in FIG. 10 may be implemented in a server process, such as resource server process 406 in FIG. 4. This process is typically initiated when a user is bumped or has a reservation canceled based on a higher priority of another user with respect to a room resource.

The process begins by displaying a notification (step 1000). This notification indicates that a reservation for a room resource by the user has been reallocated to another user. Thereafter, a list of available room resources is displayed (step 1002). A user input is then received (step 1004). A determination is made as to whether this user input selects a room resource (step 1006). If the input selects a room resource, the room resource is then reserved (step 1008).

With reference again to step 1006, if the user input does not select a resource, then an alternative resource process is initiated (step 1010). In this example, the room alternative resource process may be a process such as the ones illustrated in FIG. 7 or FIG. 8 as described above.

Thus, the present invention provides an improved method, apparatus, and computer instructions for allocating and reallocating room resources. The mechanism of the present invention stores parameters for room resources in a database. These attributes include, for example, a location of the room resource and various amenities included in the room resource. A user may input attributes identifying desired characteristics of a room resource. These attributes may then be used to determine whether a matching room can be found. In this manner, a user may make reservations without having to visit rooms to determine whether those rooms meet the criteria of the user.

Further, if no available room resources are present, a list of reserved room resources may be presented to the user meeting the attributes entered by the user. In this manner, the user may negotiate with other users who have made reservations. Alternatively, a priority system may be used to reallocate room resources automatically if a user has a higher priority than the person having the reservation. In this manner, the tedious nature of allocating room resources is reduced through the mechanism of the present invention.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method in a data processing system for allocating meeting room resources, the method comprising:
providing a database of meeting room resources, wherein the database includes attributes describing physical characteristics of each meeting room in the meeting room resources;
receiving a request for a meeting room, wherein the request includes at set of attributes;
determining whether the meeting room meeting the set of attributes is available;
responsive to a determination that the meeting room is available, allocating the meeting room to a user; and
responsive to a determination that the meeting room meeting the set of attributes is unavailable, presenting a set of reserved meeting room resources.

2. The method of claim 1, wherein the attributes include a room capacity and a location.

3. The method of claim 1, wherein the attributes a white board, a conference phone, wired network connections, wireless network connections, an overhead projector, and a podium.

4. The method of claim 1, wherein the presenting step comprises:
sending the set of reserved meeting room resources to a client, wherein the set of reserved meeting room resources are displayed to a user at the client.

5. The method of claim 1 further comprising:
responsive to a selection of a reserved meeting room from the set of reserved meeting room resources, presenting contact information for a reserving party of the reserved meeting room.

6. The method of claim 1 further comprising:
responsive to a selection of a reserved meeting room from the set of reserved meeting room resources by a user, determining whether the user has priority over a reserving party of the reserved meeting room; and
responsive to the user having priority over the reserving party, allocating the reserved meeting room the user.

7. The method of claim 6 further comprising:
responsive to an allocation of the reserved meeting room to the user, sending the reserving party a notification of the allocation.

8. A data processing system for allocating meeting room resources, the data processing system comprising:
providing means for providing a database of meeting room resources, wherein the database includes attributes describing physical characteristics of each meeting room in the meeting room resources;
receiving means for receiving a request for a meeting room, wherein the request includes at set of attributes;
determining means for determining whether the meeting room meeting the set of attributes is available;
allocating means, responsive to a determination that the meeting room is available, for allocating the meeting room to a user; and
presenting means, responsive to a determination that the meeting room meeting the set of attributes is unavailable, for presenting a set of reserved meeting room resources.

9. The data processing system of claim 8, wherein the attributes include a room capacity and a location.

10. The data processing system of claim 8, wherein the attributes a white board, a conference phone, wired network connections, wireless network connections, an overhead projector, and a podium.

11. The data processing system of claim 8, wherein the presenting means comprises:
sending means for sending the set of reserved meeting room resources to a client, wherein the set of reserved meeting room resources are displayed to a user at the client.

12. The data processing system of claim 8, wherein the presenting means is a first presenting means and further comprising:
second presenting means responsive to a selection of a reserved meeting room from the set of reserved meeting room resources, for presenting contact information for a reserving party of the reserved meeting room.

13. The data processing system of claim 8 wherein the determining means is a first determining means and wherein the allocating means is the first allocating means and further comprising:
second determining means, responsive to a selection of a reserved meeting room from the set of reserved meeting room resources by a user, for determining whether the user has priority over a reserving party of the reserved meeting room; and
second allocating means, responsive to the user having priority over the reserving party, for allocating the reserved meeting room the user.

14. The data processing system of claim 13 further comprising:
sending means, responsive to an allocation of the reserved meeting room to the user, for sending the reserving party a notification of the allocation.

15. A computer program product in a computer readable medium for allocating meeting room resources, the computer program product comprising:
first instructions for providing a database of meeting room resources, wherein the database includes attributes describing physical characteristics of each meeting room in the meeting room resources;
second instructions for receiving a request for a meeting room, wherein the request includes at set of attributes;
third instructions for determining whether the meeting room meeting the set of attributes is available;
fourth instructions, responsive to a determination that the meeting room is available, for allocating the meeting room to a user; and
fifth instructions, responsive to a determination that the meeting room meeting the set of attributes is unavailable, for presenting a set of reserved meeting room resources.

16. The computer program product of claim 15, wherein the attributes include a room capacity and a location.

17. The computer program product of claim 15, wherein the attributes a white board, a conference phone, wired network connections, wireless network connections, an overhead projector, and a podium.

18. The computer program product of claim 15, wherein the fifth instructions comprises:
sub-instructions for sending the set of reserved meeting room resources to a client, wherein the set of reserved meeting room resources are displayed to a user at the client.

19. The computer program product of claim 15 wherein the fifth instructions includes:
sub-instructions responsive to a selection of a reserved meeting room from the set of reserved meeting room resources, for presenting contact information for a reserving party of the reserved meeting room.

20. The computer program product of claim 15 further comprises:
sixth instructions responsive to a selection of a reserved meeting room from the set of reserved meeting room resources by a user, for determining whether the user has priority over a reserving party of the reserved meeting room; and
seventh instructions responsive to the user having priority over the reserving party, for allocating the reserved meeting room the user.

21. The computer program product of claim 20 further comprising:
eighth instructions responsive to an allocation of the reserved meeting room to the user, for sending the reserving party a notification of the allocation.

22. A data processing system comprising:
a bus system;
a memory connected to the bus system, wherein the memory includes a set of instructions; and
a processing unit connected to the bus system, wherein the processing unit executes the set of instructions to provide a database of meeting room resources wherein the database includes attributes describing physical characteristics of each meeting room in the meeting room resources; receive a request for a meeting room, wherein the request includes at set of attributes; determine whether the meeting room meeting the set of attributes is available; allocate the meeting room to a user in response to a determination that the meeting room is available; and present a set of reserved meeting room resources in response to a determination that the meeting room meeting the set of attributes is unavailable.
